(19) United States
(12) Patent Application Publication
(10) Pub. No.: US 2025/0125862 A1
(43) Pub. Date: Apr. 17, 2025

(54) POLYHEDRAL ANTENNA FOR LOW-EARTH-ORBIT SATELLITE SYSTEMS

(71) Applicant: Hughes Network Systems, LLC, Germantown, MD (US)

(72) Inventors: Udaya Bhaskar, North Potomac, MD (US); Stanley Kay, Rockville, MD (US); Lin-Nan Lee, Potomac, MD (US)

(21) Appl. No.: 18/487,500

(22) Filed: Oct. 16, 2023

(51) Int. Cl. H04B 7/185; H01Q 1/28

(52) U.S. Cl. CPC H04B 7/18515; H01Q 1/288

(57) ABSTRACT

Polyhedral antenna systems are described for improving satellite communication links. Using conventional planar satellite antennas, user terminals closer to the edge of coverage (EoC) of the antenna tend to experience appreciable scan loss relative to user terminals closer to the nadir. Polyhedral antenna systems described herein (e.g., pyramidal antennas) include planar sub-antennas pointing in both nadir and EoC directions, which manifests an improved aggregate antenna response relative to conventional antenna approaches. For example, in orbit, the boresight of at least one sub-antenna is pointing substantially in a nadir direction, and the boresight of at least another of the sub-antennas is pointing substantially in the EoC direction. Embodiments can use interference mitigation techniques to reduce interference between sub-antennas. Ground terminals can be assigned to whichever of the sub-antennas provides the ground terminal with the highest-gain satellite link.

### BACKGROUND

In a satellite communication system, ground terminals (e.g., user terminals and gateway terminals) communicate via one or more satellites. Reliable communications can be established over a wireless satellite link by maintaining a line of sight between an antenna at a ground terminal and an antenna at a satellite. In the case of a low-Earth-orbit (LEO) satellite communication system, the satellite may be at an altitude of around 650 kilometers above the Earth. Antennas at the ground terminals are pointed with a minimum elevation angle (e.g., 20 degrees) to ensure line of sight with the satellite without interference from buildings, etc., and the antenna at the satellite is designed to have a wide field of view for large geographical coverage. Conventionally, in such LEO satellite communication systems, a user terminal near the edge of coverage of the satellite antenna (e.g., with an elevation angle of around 20 degrees) can experience appreciably worse path loss and scan loss effects as compared with a user terminal located directly below the satellite (e.g., with an elevation angle of around 90 degrees). For example, the effects can result in approximately 12 decibels of signal loss and a corresponding degradation in performance.

### SUMMARY

Systems and methods are described for improving satellite communication links by using polyhedral antenna systems. Using conventional planar satellite antennas, user terminals closer to the edge of coverage (EoC) of the antenna tend to experience appreciable scan loss relative to user terminals closer to the nadir. Polyhedral antenna systems described herein include planar sub-antennas pointing in both nadir and EoC directions, which manifests an improved aggregate antenna response relative to conventional antenna approaches. For example, in orbit, the boresight of at least one sub-antenna is pointing substantially in a nadir direction, and the boresight of at least another of the sub-antennas is pointing substantially in the EoC direction. Some implementations are pyramidal antennas that can include a top surface and multiple (e.g., four) slanted surfaces. In some embodiments, interference mitigation techniques are applied to reduce interference between sub-antennas. Ground terminals can be assigned to whichever of the sub-antennas provides the ground terminal with the highest-gain satellite link.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative satellite communication environment in which a satellite communicates with ground terminals, such as user terminals and gateway terminals.

FIG. 2A shows a plot of path loss versus elevation angle for user terminals communicating with a satellite at an altitude of approximately 650 kilometers.

FIG. 2B shows a plot of gain versus scan angle for a typical patch of a satellite planar microstrip patch antenna.

FIGS. 3A and 3B show a side view and a top view, respectively, of an illustrative polyhedral antenna system, according to embodiments described herein.

FIGS. 4A and 4B show two simulated response contour plots for a polyhedral antenna. These two Figures are in color.

FIG. 5A shows a plot of antenna gain versus off-boresight angle for a polyhedral antenna.

FIG. 5B shows a plot of antenna gain versus off-boresight angle for a conventional planar antenna.

FIG. 6 shows a flow diagram of an illustrative method for providing a polyhedral antenna system for a low-Earth-orbit (LEO) satellite, according to embodiments described herein.

FIG. 7 shows a flow diagram of an illustrative method for providing satellite communications between a plurality of ground terminals and a low-Earth-orbit (LEO) satellite using a polyhedral antenna, according to embodiments described herein.

### DETAILED DESCRIPTION

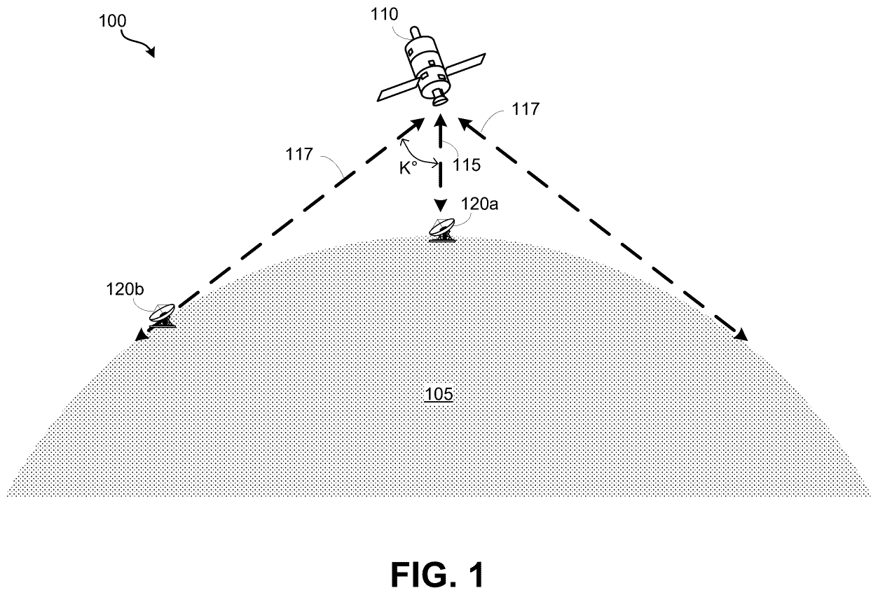

In a satellite communication system, ground terminals (e.g., user terminals and gateway terminals) communicate via one or more satellites. Reliable communications can be established over a wireless satellite link by maintaining a line of sight between an antenna at a ground terminal and an antenna at a satellite. For the sake of context, FIG. 1 shows an illustrative satellite communication environment 100 in which a satellite 110 communicates with ground terminals 120, such as user terminals and gateway terminals. The satellite 110 is assumed to be a low-Earth-orbit (LEO) satellite. LEO satellites typically orbit the Earth 105 at altitudes of less than 2,000 kilometers. For example, the illustrated satellite 110 can be at an orbital altitude of approximately 650 kilometers above the Earth 105.

The ground terminals 120 communicate with the satellite 110 by pointing an antenna at the satellite 110 and maintaining line of sight with the satellite 110. Each ground terminal 120 will have a respective elevation angle by which it is pointing to the satellite 110. For example, a first user terminal 120a is illustrated as being located directly below the satellite 110, and a second user terminal 120b is illustrated as being located as far away as possible from the satellite 110, while still being able to have a line of sight to the satellite 110. Typically, ground terminals 120 are assumed to have a minimum elevation angle below which their line of sight will tend to be obstructed. For example, the first user terminal 120a is pointed at the maximum elevation angle of approximately 90 degrees (i.e., pointing straight up), and the second user terminal 120b is pointed at the minimum elevation angle (e.g., 20 degrees).

The satellite 110 antenna effectively has a field of view (i.e., an illumination region of a conical spot beam) that can be defined based on the altitude of the satellite 110 and the minimum elevation angle of ground terminals 120, and the edge of the field of view can effectively define an edge of coverage (EoC) of the satellite 110 antenna. For example, any user terminals 120 past the EoC (i.e., outside of the field of view of the satellite 110 antenna) is assumed to be outside the communication coverage area of the satellite 110. The direction pointing straight down to the Earth 105 from the satellite 110 antenna (represented by arrow 115) is referred to herein as the nadir direction, and the direction pointing to the EoC of the satellite 110 antenna (represented by arrows 117) is referred to herein as the EoC direction. As illustrated, the EoC direction and the nadir direction form an angle of K degrees. For example, at an altitude of 650 kilometers and a minimum elevation angle of 20 degrees, K is approximately 58.2 degrees (in all directions, forming a cone with its vertex at the satellite 110).

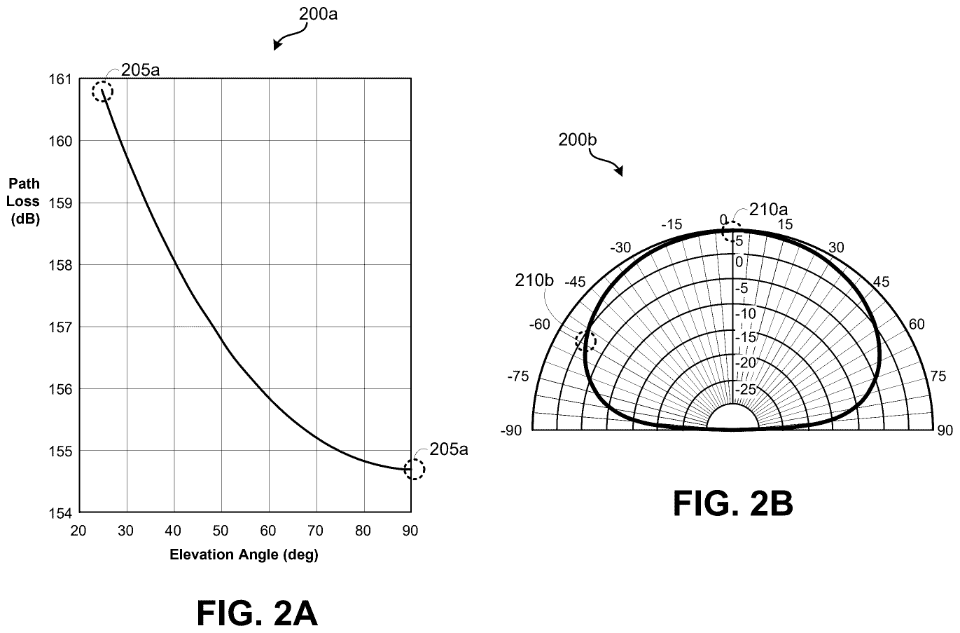

User terminals 120 close to the EoC of the satellite 110 antenna (e.g., user terminal 120b) tend to be appreciably disadvantaged relative to user terminals 120 close to the nadir of the satellite 110 antenna (e.g., user terminal 120a). One factor that disadvantages user terminals 120 closer to the EoC of the satellite 110 antenna is a large difference in path loss. It can be seen that the distance from the satellite 110 to the first user terminal 120a along the nadir direction is much shorter (e.g., approximately half, in some cases) than the distance from the satellite to the second user terminal 120b along the EoC direction, corresponding to a large difference in free space optical path length between the satellite 110 and different user terminals 120. The large difference in path length can manifest a large difference in path loss. For example, FIG. 2A shows a plot 200a of path loss versus elevation angle for user terminals 120 communicating with a satellite at an altitude of approximately 650 kilometers. As illustrated, a user terminal 120 with an elevation angle of approximately 90 degrees (e.g., user terminal 120a) experiences a path loss of close to 155 decibels (indicated as region 205a of the plot 200a), while a user terminal 120 with an elevation angle of approximately 20 degrees (e.g., user terminal 120b) experiences a path loss of close to 161 decibels (indicated as region 205b of the plot 200a); approximately a 6-decibel difference in path loss.

Another factor that disadvantages user terminals 120 closer to the EoC of the satellite 110 antenna is a large scan loss over the field of view. As noted above, there is a K-degree difference (e.g., 58.2 degrees) between the nadir direction and the EoC direction. Conventionally, the satellite 110 antenna is a planar patch antenna. Each patch of the antenna experiences a scan loss corresponding to the scan angle, and a large difference in angle between the nadir and EoC directions can manifest as a large difference in scan loss. For example, FIG. 2B shows a plot 200b of gain versus scan angle for a typical patch of a satellite planar microstrip patch antenna. The plot 200b assumes a square patch having a dielectric constant of 4.0 and a height and width of 3.75 centimeters (i.e., one quarter-wavelength at 2 Gigahertz). As illustrated, a patch typically achieves approximately 5 decibels of gain at zero degrees of scan (i.e., when pointing in the nadir direction) as indicated by region 210a of the plot 200b, while the same patch typically achieves approximately negative 1 decibel of gain at 58.2 degrees of scan (i.e., when pointing in the EoC direction of examples described herein) as indicated by region 210b of the plot 200b; approximately a 6-decibel scan loss. Combining the difference in path loss with the scan loss yields approximately a 12-decibel degradation for user terminals 120 close to the EoC of the field of view as compared to those close to the center of the field of view.

Embodiments described herein seek at least to mitigate scan losses experienced by user terminals closer to the EoC of the satellite 110 antenna by providing a polyhedral antenna having planar sub-antennas pointing in both the nadir and EoC directions. For example, each face of the polyhedral antenna has a respective planar sub-antenna disposed thereon, such that the angle of the face (i.e., the face defines a normal vector, and the angle of the face corresponds to the angle of the normal vector) defines a boresight direction of the respective sub-antenna. The polyhedral antenna is configured so that, when mounted to a satellite and the satellite is in orbit, at least one of the boresight directions is pointing substantially collinearly with the nadir direction, and at least another of the boresight directions is pointing substantially collinearly with the EoC direction. In some embodiments, sub-antennas having overlapping fields of view can communicate concurrently using interference mitigation techniques, such as different carriers (or sub-carriers), orthogonality, time division multiplexing, or the like. Ground terminals can be assigned to whichever of the sub-antennas provides the ground terminal with the highest-gain satellite link. For example, user terminals pointing at or near the maximum elevation angle are assigned to the sub-antenna having a boresight pointing substantially collinearly with the nadir direction, and user terminals pointing at or near the minimum elevation angle are assigned to the sub-antenna having a boresight pointing substantially collinearly with the EoC direction.

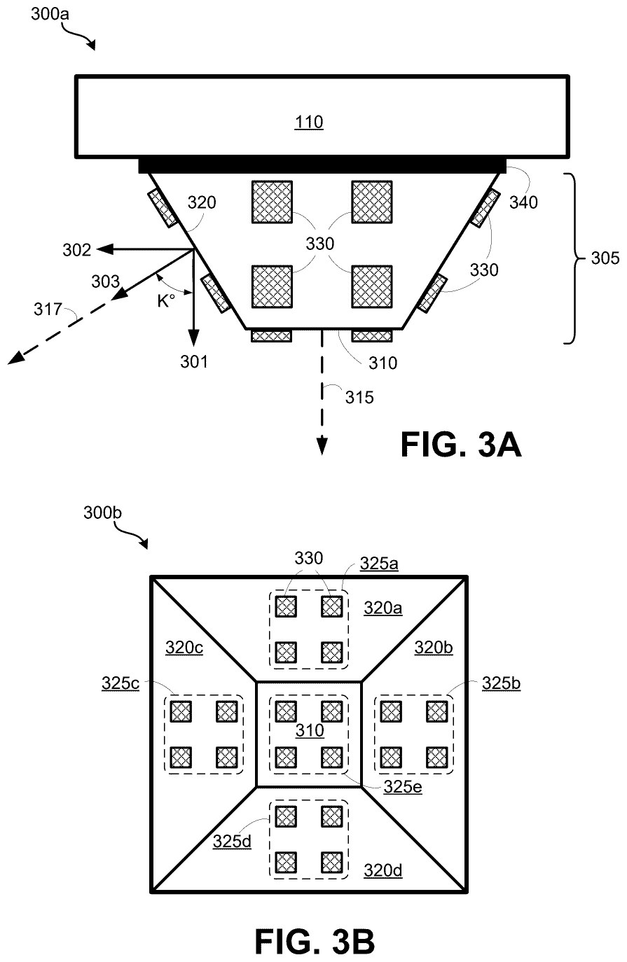

FIGS. 3A and 3B show a side view and a top view, respectively, of an illustrative polyhedral antenna system 300, according to embodiments described herein. The side view of FIG. 3A is shown in context of a satellite 110, such as a LEO satellite, to which a polyhedral antenna 305 of the polyhedral antenna system 300 is mounted via a mounting structure 340. The top view shown in FIG. 3B does not show either the satellite 110 or the mounting structure 340. The mounting structure 340 mounts the polyhedral antenna 305 to the satellite 110 (e.g., to an Earth deck of the satellite 110) in a defined orientation: the orientation of the polyhedral antenna 305 relative to the Earth is fixed to the orientation of the satellite 110 relative to the Earth via the mounting structure 340. In particular, the mounting structure 340 orients a nadir direction 301 of the polyhedral antenna 305 to point directly at the Earth when the satellite 110 is in its orbital orientation. The mounting structure 340 can include any suitable structural elements for fixing and orienting the polyhedral antenna 305 to the satellite 110, such as support structures, fasteners, fairings, etc. Further, the mounting structure is configured to support and/or facilitate any power and signal couplings between the satellite 110 and the polyhedral antenna 305.

The polyhedral antenna 305 is a polyhedron having multiple planar surfaces. Each of some or all of the planar surfaces has a respective planar sub-antenna 325 disposed thereon. The polyhedral antenna 305 is designed to have a nadir direction 310 and an edge of coverage (EoC) direction 303, as described with respect to FIG. 1. As described herein, the EoC direction 303 is angled K degrees from the nadir direction 301 (e.g., 58.2 degrees). The nadir direction 301 may be substantially perpendicular to a so-called horizon direction 302, which may also lie substantially in the plane of the mounting deck (e.g., the Earth deck) of the satellite 110, as shown. At least one planar surface is a top surface 310 of the polyhedron, such that a normal vector of the top surface 310 points in the nadir direction 310 of the polyhedral antenna 305, as represented by arrow 315. Although referred to as the “top” surface 310, this surface will be pointing directly down towards the Earth when the polyhedral antenna 305 is in orbit. At least another planar surface is a slanted surface 320 of the polyhedron, such that a normal vector of each slanted surface 320 points in the EoC direction 303 of the polyhedral antenna 305, as represented by arrow 317. For example, each slanted surface 320 is slanted K degrees relative to the top surface 310. This slant of K degrees corresponds to the EoC direction 303 and can also be referred to as a maximum slant direction. As described herein, slanted faces can also be pointed at an angle less than the maximum slant direction in some embodiments.

The particular implementation illustrated in FIGS. 3A and 3B is a pyramidal polyhedral antenna 305 having five surfaces: the top surface 310 and four slanted surfaces 320. Each of the four slanted surfaces 320 is slanted K degrees relative to the top surface 310 in an orthogonal direction. For example, a convention can be established with a z-axis pointing in the nadir direction 301 (down relative to the drawing page), an x-axis pointing in the horizon direction 302 (left relative to the drawing page), and the y-axis pointing into the drawing page. According to such a convention, a normal vector of the top surface 310 points in the positive Z direction, and the normal vectors of the four slanted surfaces 320 are rotated 58.2 degrees in a Z-Y plane, −58.2 degrees in a Z-Y plane, 58.2 degrees in a Z-X plane, and −58.2 degrees in a Z-Y plane, respectively. In such a configuration, all four slanted surfaces 320 are pointing in the EoC direction 303, but are 90-degrees rotationally offset from each other around the z-axis (i.e., pointing in orthogonal directions). In another implementation, the polyhedral antenna 305 is configured as a pyramidal antenna with four sides: a top surface 310 and three slanted surfaces 320 that are 120-degrees rotationally offset from each other around the z-axis. Here, too, all of the slanted surfaces 320 can be pointing in the EoC direction 303 while also pointing orthogonally to each other. Other implementations can include different numbers of slanted surfaces 320 and/or different rotational offsets between the slanted surfaces 320.

Each of at least the top surface 310 and the tilted surface 320 (corresponding to some or all of the surfaces of the polyhedral antenna 305) has a respective sub-antenna 325 disposed thereon. Each sub-antenna 325 can be implemented in any suitable way to have a boresight pointing in its desired direction. In particular, the top surface 310 can have a nadir-facing sub-antenna 325 disposed thereon (e.g., sub-antenna 325e), and each slanted surface 320 can have an EoC-facing sub-antenna 325 disposed thereon (e.g., sub-antennas 325a-325d). Some implementations can also include additional surfaces with normal vectors pointing in other directions, such as pointing in neither the nadir direction 301 nor the EoC direction 303. For example, embodiments can include one or more intermediate-facing sub-antennas 325. Such intermediate-facing sub-antennas 325 can be integrated with the mounting structure 340 to have an intermediate-facing boresight pointing in a direction that is angled greater than zero and less than K degrees from the nadir direction.

In the illustrated embodiment, each sub-antenna 325 is a planar array of radiating elements 330. For example, each sub-antenna 325 is a planar microstrip patch antenna, in which each radiating element 330 is a “patch” designed for particular radiation characteristics. In some such implementations, each patch is a square patch that has a length and width corresponding to a quarter-wavelength of an operating frequency (e.g., a carrier frequency) of the sub-antenna 325 (or of the polyhedral antenna 305). For example, at 2 Gigahertz, each patch can have a length and width of approximately 3.75 centimeters. Other embodiments can implement the sub-antennas 325 using different types of patches (e.g., circular patches), or other types of radiating elements 330. The radiating elements 330 can also be spaced for desired radiation characteristics. For example, each radiating element 330 can be spaced apart from its neighbors by a distance of approximately a half-wavelength of the operating frequency (e.g., approximately 7.5 centimeters at 2 Gigahertz). In the illustrated embodiment, each sub-antenna 325 is a two-by-two array of radiating elements 330. Other embodiments can implement the sub-antennas 325 using different numbers of radiating elements 330 (e.g., different array size), different arrangements of radiating elements 330, different spacing between radiating elements 330, etc. For example, changing the number of radiating elements 330 and/or other parameters of the sub-antenna 325 can affect radiating characteristics of the sub-antennas 325, such as the operating range of frequencies, amount of interference between sub-antennas 325, directionality of the sub-antennas 325, beam width produced by the sub-antennas 325, etc.

Although some descriptions herein assume that each sub-antenna 325 lies in the same plane as the polyhedral surface on which it is disposed, some embodiments can mechanically and/or electrically adjust the orientation of one or more sub-antennas 325 relative to their underlying polyhedral surfaces. For example, the sub-antenna 325 can be mounted to an underlying polyhedral surface via a physical structure that affects the physical pointing of the sub-antenna 325. As another example, signal phasing (e.g., beam weighting) across the array of the sub-antenna 325 can be used to electronically point the sub-antenna 325. In such embodiments, the sub-antenna 325 can have a boresight pointing in a direction that is angled relative to the normal vector of the underlying surface. For example, each slanted surface 320 is slanted by only 45 degrees, but each corresponding EoC-facing sub-antenna 325 is still mechanically and/or electronically pointed to a boresight of 58.2 degrees.

Such embodiments can be used to address several technical constraints. One such constraint is tolerance. In some cases, it may be desirable to point the boresights of the antennas with greater accuracy than is achieved through the physical mounting of the polyhedral antenna 305 to the satellite 110 (e.g., and/or with greater accuracy than the attitude control of the satellite 110, etc.). In such cases, mechanical and/or electronic pointing can be used to ensure that the pointing of the sub-antennas 325 is correct and/or within the desired tolerance. Another such constraint is payload. The satellite 110 is typically deployed as payload of a launch vehicle, such that the satellite 110 must fit within the launch bay of the launch vehicle during deployment. Slanting polyhedral surfaces to the maximum slant direction may result in a fairing size that exceeds the physical space of the launch bay (or some other physical space constraint). In such cases, the polyhedral antenna 305 can be implemented with slanted surfaces 320 that are less slanted than the maximum slant direction, while still being able to point the EoC-facing sub-antennas 325 in the EoC direction 303.

In other embodiments, a sufficient amount of performance gain is achieved by pointing the sub-antennas 325 in a direction close to their nominal directions, such as by pointing the nadir-facing sub-antenna 325 in a direction sufficiently close to the nadir direction 301 and/or pointing the EoC-facing sub-antennas 325 in a direction sufficiently close to the EoC direction 303. In some such embodiments, each sub-antenna 325 has a boresight pointing in a direction that is ±10 degrees from its nominal direction. For example, the each EoC-facing sub-antenna 325 has a boresight pointing at between 48 degrees and 68 degrees for a 58-degree EoC direction 303. In other such embodiments, each sub-antenna 325 has a boresight pointing in a direction that is ±5 degrees from its nominal direction. For example, the each EoC-facing sub-antenna 325 has a boresight pointing at between 53 degrees and 63 degrees for a 58-degree EoC direction 303.

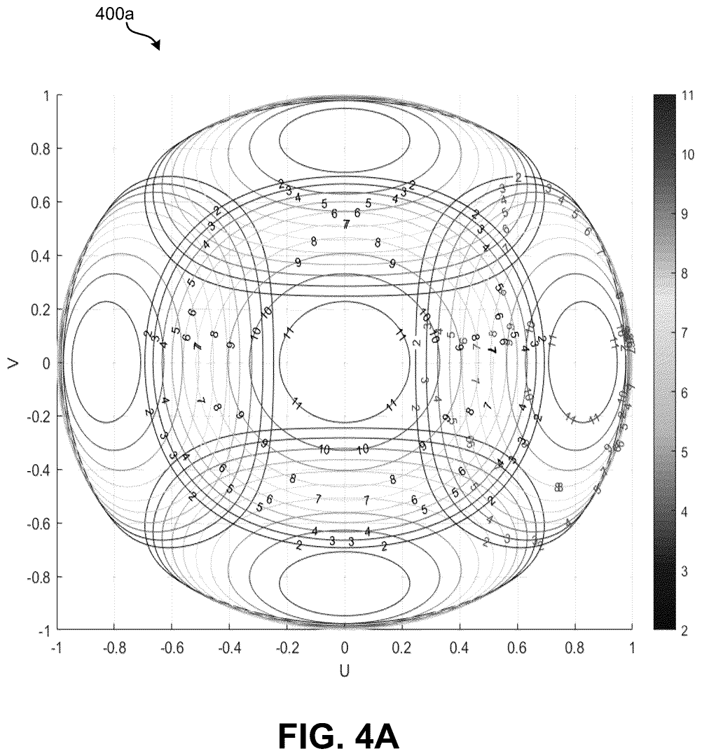

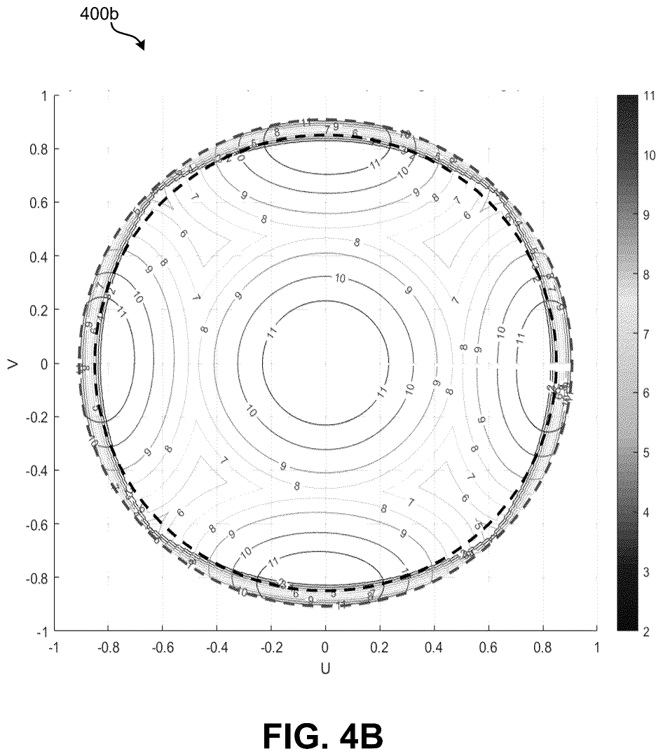

FIGS. 4A and 4B show two simulated response contour plots 400 for a polyhedral antenna 305. Consistent with the illustrated embodiment of FIGS. 3A and 3B, the response contour plots 400 assume a five-sided pyramid-shaped polyhedral antenna 305 having a top surface 310 and four slanted surfaces 320, each slanted by 58.2 degrees. The response contour plots 400 further assume that each surface has a respective sub-antenna 325 implemented as a respective two-by-two microstrip patch array. The plots 400 show antenna gain without accounting for path loss.

The response contour plot 400a of FIG. 4A shows the response contours for all five sub-antennas 325 overlaid onto a single plot. The response contour plot 400b of FIG. 4B shows a highest response at each location from among the individual responses of the five sub-antennas 325. For example, it can be seen in FIG. 4A that each sub-antenna 325 has a peak directivity of over 11 decibels in its respective boresight direction, and the response drops with increasing distance from the respective boresight direction. However, FIG. 4B demonstrates that the aggregate response does not drop below around 6 decibels. As such, by assigning ground terminals to whichever of the sub-antennas 325 can provide the highest gain link, the minimum gain across all ground terminals can be appreciably higher than with a single planar antenna pointing only in the nadir direction.

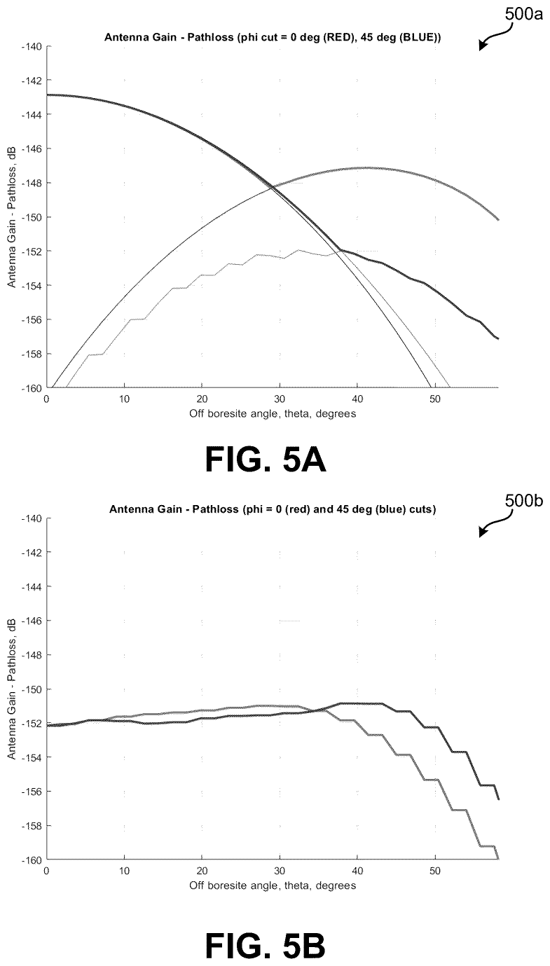

A similar effect can be seen in FIGS. 5A and 5B. FIG. 5A shows a plot 500a of antenna gain minus path loss versus off-boresight angle for a polyhedral antenna 305. As in FIGS. 4A and 4B, the plot 500a assumes a five-sided pyramid-shaped polyhedral antenna 305 having a top surface 310 and four slanted surfaces 320, each slanted by 58.2 degrees, each surface having a respective sub-antenna 325 implemented as a two-by-two microstrip patch array. For the sake of comparison, FIG. 5B shows a plot 500b of antenna gain minus path loss versus off-boresight angle for a conventional planar antenna.

The plot 500a of FIG. 5A demonstrates that the antenna gain minus path loss of the polyhedral antenna 305 stays between about −141 decibels and about −150 decibels for a 0-degree phi cut for all off-boresight angles between the nadir direction (0 degrees) and the EoC direction (58.2 degrees). The pot 500b of FIG. 5B demonstrates that, even for a conventional planar antenna designed to yield close to an isoflux response for off-boresight angles between 0 and 45 degrees, the response quickly and significantly drops off for larger off-boresight angles. For example, at the EoC direction, the conventional planar antenna provides almost 7 decibels lower response relative to that of the polyhedral antenna 305.

Referring back to FIG. 4A, it can be seen that the multiple sub-antennas 325 can have overlapping responses, which can cause interference. Decreasing the number of sub-antennas 325 (e.g., decreasing the number of polyhedral surfaces) can tend to decrease such interference, but also tends to degrade the aggregate response characteristics of the polyhedral antenna 305. Increasing the directivity of the sub-antennas 325 (e.g., by increasing the array size) can also tend to reduce such interference, but also tends to degrade the aggregate response characteristics of the polyhedral antenna 305. Embodiments can use one or more other types of interference mitigation techniques to reduce interference between sub-antennas 325 without degrading the aggregate response characteristics of the polyhedral antenna 305.

One interference mitigation technique is to assign different carriers (e.g., or sub-carriers) to the different sub-antennas 325. In some implementations, a polyhedral antenna 305 with N sub-antennas 325 (N is an integer greater than one) is configured so that each of the N sub-antennas 325 is assigned to a different (non-overlapping) respective one of the N carriers. For example, in the embodiment of FIGS. 3A and 3B, five different carriers are assigned to the five sub-antennas 325. In some implementations of a polyhedral antenna 305 with N sub-antennas 325, M disjoint subsets of the N antennas can be identified (M<N), such that each of the subsets has at least one sub-antenna 325, and all sub-antennas 325 in a given subset have substantially non-overlapping response contours. For example, in the embodiment of FIGS. 3A and 3B, three different carriers are assigned to the five sub-antennas 325: a first carrier is assigned to a first subset having only sub-antenna 325e; a second carrier is assigned to a second subset having sub-antennas 325a and 325d; and a third carrier is assigned to a third subset having sub-antennas 325b and 325c (the contour plot 400a of FIG. 4A demonstrates that these subsets are substantially non-overlapping). In this context, the term “substantially non-overlapping” is intended to mean that there is either no overlap at all, or the gain of the potentially interfering signal in the overlapping regions is small enough to be easily rejected by impacted ground terminals. Some embodiments can use other interference mitigation techniques, such as assigning potentially interfering sub-antennas 325 to different orthogonalities (e.g. to different polarization orientations, etc.), assigning potentially interfering sub-antennas 325 to different time slots (e.g., using time-division multiplexing), etc.

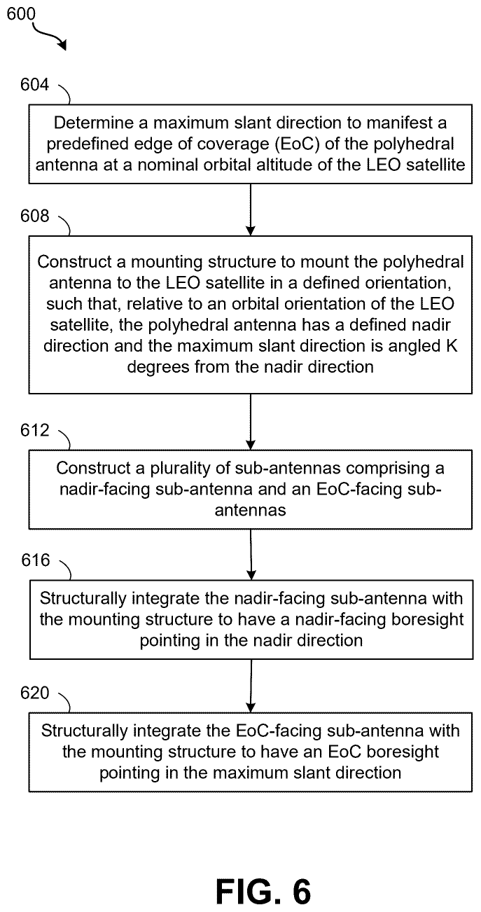

FIG. 6 shows a flow diagram of an illustrative method 600 for providing a polyhedral antenna system for a low-Earth-orbit (LEO) satellite, according to embodiments described herein. Embodiments of the method 600 begin at stage 604 by determining a maximum slant direction to manifest a predefined edge of coverage (EoC) of the polyhedral antenna at a nominal orbital altitude of the LEO satellite. At stage 608, embodiments can construct a mounting structure to mount the polyhedral antenna to the LEO satellite in a defined orientation. As described herein, the mounting is such that, relative to an orbital orientation of the LEO satellite, the polyhedral antenna has a defined nadir direction and the maximum slant direction is angled K degrees from the nadir direction. K can be any suitable non-zero angle, such as 58.2 degrees. At stage 612, embodiments can construct multiple sub-antennas, including a nadir-facing sub-antenna and at least one EoC-facing sub-antenna. At stage 616, embodiments can structurally integrate the nadir-facing sub-antenna with the mounting structure to have a nadir-facing boresight pointing in the nadir direction. At stage 620, embodiments can structurally integrate the EoC-facing sub-antenna with the mounting structure to have an EoC boresight pointing in the maximum slant direction.

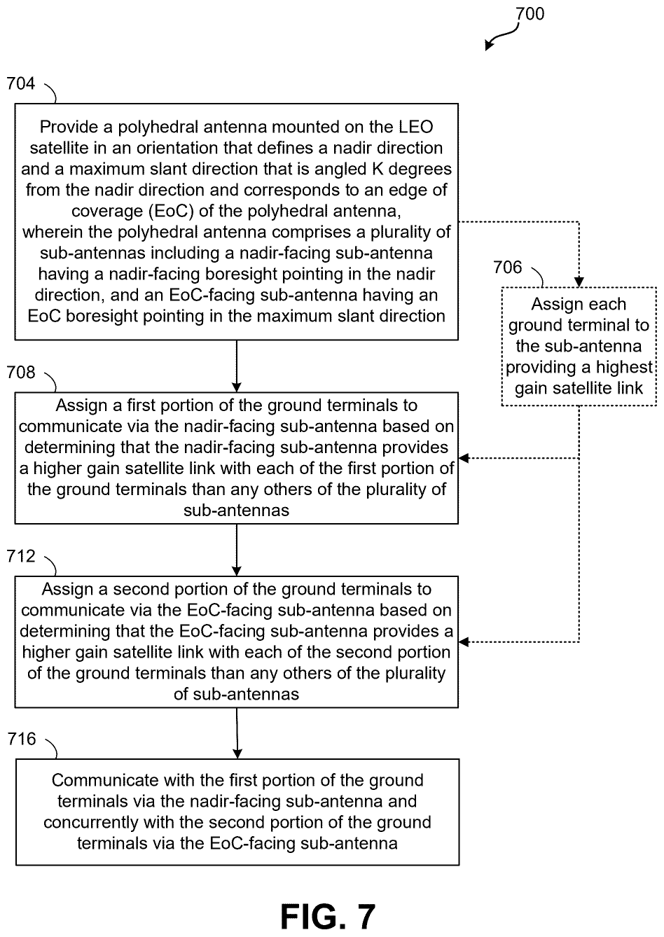

FIG. 7 shows a flow diagram of an illustrative method 700 for providing satellite communications between a plurality of ground terminals and a low-Earth-orbit (LEO) satellite using a polyhedral antenna, according to embodiments described herein. Embodiments of the method begin at stage 704 by providing a polyhedral antenna mounted on the LEO satellite in an orientation that defines a nadir direction and a maximum slant direction that is angled K degrees from the nadir direction and corresponds to an edge of coverage (EoC) of the polyhedral antenna. As described herein, the polyhedral antenna has multiple sub-antennas, including a nadir-facing sub-antenna having a nadir-facing boresight pointing in the nadir direction, and at least one EoC-facing sub-antenna having an EoC boresight pointing in the maximum slant direction.

At stage 708, embodiments can assign a first portion of the ground terminals to communicate via the nadir-facing sub-antenna based on determining that the nadir-facing sub-antenna provides a higher gain satellite link with each of the first portion of the ground terminals than any others of the plurality of sub-antennas. At stage 712, embodiments can assign a second portion (i.e., a disjoint subset) of the ground terminals to communicate via the EoC-facing sub-antenna based on determining that the EoC-facing sub-antenna provides a higher gain satellite link with each of the second portion of the ground terminals than any others of the plurality of sub-antennas. For example, each of all the ground terminals is assigned to whichever of the sub-antennas provides the highest quality link. As used herein, determining which sub-antenna provides a highest gain link for a particular ground terminal can involve determining which sub-antenna has the highest gain at an off-boresight angle associated with the ground terminal, accounting for path loss at that off-boresight angle. For example, some embodiments, at stage 706, assign each ground terminal (of all the ground terminals) to a respective one of the sub-antennas determined as providing the highest-gain satellite link for that ground terminal (e.g., based on the off-boresight angle determined for the ground terminal).

At stage 716, embodiments can communicate with the first portion of the ground terminals via the nadir-facing sub-antenna and concurrently with the second portion of the ground terminals via the EoC-facing sub-antenna. In some embodiments, the communicating at stage 716 involves communicating with the first portion of the ground terminals via the nadir-facing sub-antenna using a first carrier (e.g., or sub-carrier) and concurrently with the second portion of the ground terminals via the EoC-facing sub-antenna using a second carrier (e.g., or sub-carrier).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A polyhedral antenna system for a low-Earth-orbit (LEO) satellite, the polyhedral antenna system comprising:
a mounting structure to mount to the LEO satellite in a defined orientation;
a polyhedral antenna integrated with the mounting structure, such that relative to an orbital orientation of the LEO satellite, the polyhedral antenna has a defined nadir direction and a defined maximum slant direction that is angled K degrees from the nadir direction and corresponds to an edge of coverage (EoC) of the polyhedral antenna, wherein K is not equal to zero, the polyhedral antenna comprising:
a nadir-facing sub-antenna integrated with the mounting structure to have a nadir-facing boresight pointing in the nadir direction; and
an EoC-facing sub-antenna integrated with the mounting structure to have an edge-of-coverage (EoC) boresight pointing in the maximum slant direction.

2. The polyhedral antenna system of claim 1, wherein:
the nadir-facing sub-antenna comprises a first array of antenna elements configured to radiate according to the nadir boresight; and
the EoC-facing sub-antenna comprises a second array of antenna elements configured to radiate according to the EoC boresight.

3. The polyhedral antenna system of claim 2, wherein:
each of the first and second arrays is a planar array of at least one antenna element.

4. The polyhedral antenna system of claim 1, wherein:
N is a positive integer greater than 1;
the EoC-facing sub-antenna is one of N EoC-facing sub-antennas, each having a respective array of radiating elements configured to radiate in a respective one of N pointing directions; and
each of the N pointing directions corresponds to the maximum slant direction and is orthogonal to at least one other of the N pointing directions.

5. The polyhedral antenna system of claim 4, wherein:
each of the N sub-antennas is assigned to communicate using a different respective one of N carriers.

6. The polyhedral antenna system of claim 4, wherein:
the N sub-antennas are grouped into M disjoint subsets, N>2 and M<N, and all of the sub-antennas in any subset are substantially non-overlapping; and
each subset is assigned to communicate using a different respective one of M carriers.

7. The polyhedral antenna system of claim 1, wherein:
the polyhedral antenna is a pyramidal structure having a top surface and four slanted side surfaces;
each side surface is angled relative to the top surface so that a normal vector of the top surface points in the nadir direction, and a normal vector of each side surface points in a direction that is angled K degrees from the nadir direction;
the nadir-facing sub-antenna is disposed on the top surface; and
the EoC-facing sub-antenna is one of four EoC-facing sub-antennas, each disposed on a respective one of the four side surfaces.

8. The polyhedral antenna system of claim 7, wherein:
the polyhedral antenna is configured to operate at five different carrier frequencies;
the nadir-facing sub-antenna is configured to operate at a first of the five different carrier frequencies; and
each of four EoC-facing sub-antennas is configured to operate at a respective one of a second, third, fourth, or fifth of the five different carrier frequencies.

9. The polyhedral antenna system of claim 7, wherein:
the polyhedral antenna is configured to operate at three different carrier frequencies;
the nadir-facing sub-antenna is configured to operate at a first of the three different carrier frequencies;
a first pair of the four EoC-facing sub-antennas is configured to operate at a second of the three different carrier frequencies, the first pair being disposed opposite each other on the polyhedral antenna; and
a second pair of the four EoC-facing sub-antennas is configured to operate at a third of the three different carrier frequencies, the second pair being disposed opposite each other on the polyhedral antenna.

10. The polyhedral antenna system of claim 1, wherein the polyhedral antenna further comprises:
an intermediate-facing sub-antenna integrated with the mounting structure to have an intermediate-facing boresight pointing in a direction that is angled greater than zero and less than K degrees from the nadir direction.

11. The polyhedral antenna system of claim 1, wherein:
the mounting structure is configured to mount the polyhedral antenna to an Earth deck of the LEO satellite.

12. The polyhedral antenna system of claim 1, wherein:
maximum slant direction is angled between 55 and 65 degrees from the nadir direction.

13. A method for providing a polyhedral antenna system for a low-Earth-orbit (LEO) satellite, the method comprising:
determining a maximum slant direction to manifest a predefined edge of coverage (EoC) of the polyhedral antenna at a nominal orbital altitude of the LEO satellite;
constructing a mounting structure to mount the polyhedral antenna to the LEO satellite in a defined orientation, such that relative to an orbital orientation of the LEO satellite, the polyhedral antenna has a defined nadir direction and the maximum slant direction is angled K degrees from the nadir direction, wherein K is not equal to zero;
constructing a plurality of sub-antennas comprising a nadir-facing sub-antenna and an EoC-facing sub-antenna;
structurally integrating the nadir-facing sub-antenna with the mounting structure to have a nadir-facing boresight pointing in the nadir direction; and
structurally integrating the EoC-facing sub-antenna with the mounting structure to have an EoC boresight pointing in the maximum slant direction.

14. The method of claim 13, wherein:
the constructing the plurality of sub-antennas comprises constructing, for each sub-antenna, a respective planar array of radiating elements.

15. The method of claim 13, wherein:
the polyhedral antenna is a pyramidal structure having a top surface and four slanted side surfaces;
each side surface is angled relative to the top surface so that a normal vector of the top surface points in the nadir direction, and a normal vector of each side surface points in a direction that is angled K degrees from the nadir direction;
the nadir-facing sub-antenna is disposed on the top surface; and
the EoC-facing sub-antenna is one of four EoC-facing sub-antennas, each disposed on a respective one of the four side surfaces.

16. A method for providing satellite communications between a plurality of ground terminals and a low-Earth-orbit (LEO) satellite, the method comprising:
providing a polyhedral antenna mounted on the LEO satellite in an orientation that defines a nadir direction and a maximum slant direction that is angled K degrees from the nadir direction and corresponds to an edge of coverage (EoC) of the polyhedral antenna, wherein K is not equal to zero,
wherein the polyhedral antenna comprises a plurality of sub-antennas including a nadir-facing sub-antenna having a nadir-facing boresight pointing in the nadir direction, and an EoC-facing sub-antenna having an EoC boresight pointing in the maximum slant direction;
assigning a first portion of the ground terminals to communicate via the nadir-facing sub-antenna based on determining that the nadir-facing sub-antenna provides a higher gain satellite link with each of the first portion of the ground terminals than any others of the plurality of sub-antennas;
assigning a second portion of the ground terminals to communicate via the EoC-facing sub-antenna based on determining that the EoC-facing sub-antenna provides a higher gain satellite link with each of the second portion of the ground terminals than any others of the plurality of sub-antennas;
communicating with the first portion of the ground terminals via the nadir-facing sub-antenna and concurrently with the second portion of the ground terminals via the EoC-facing sub-antenna.

17. The method of claim 16, wherein the communicating comprises:
communicating with the first portion of the ground terminals via the nadir-facing sub-antenna using a first carrier and concurrently with the second portion of the ground terminals via the EoC-facing sub-antenna using a second carrier.

18. The method of claim 16, further comprising:
assigning each ground terminal of the plurality of ground terminals to one of the plurality of sub-antennas by, for each ground terminal:
determining an off-boresight angle associated with the ground terminal relative to the nadir direction; and
determining which of the plurality of sub-antennas provides a highest antenna gain at the associated off-boresight angle,
wherein the ground terminal is assigned as part of the assigning the first portion of the ground terminals responsive to determining that the nadir-facing sub-antenna provides the highest antenna gain at the associated off-boresight angle, and
wherein the ground terminal is assigned as part of the assigning the second portion of the ground terminals responsive to determining that the EoC-facing sub-antenna provides the highest antenna gain at the associated off-boresight angle.

19. The method of claim 16, wherein:
the polyhedral antenna is a pyramidal structure having a top surface and four slanted side surfaces;
each side surface is angled relative to the top surface so that a normal vector of the top surface points in the nadir direction, and a normal vector of each side surface points in a direction that is angled K degrees from the nadir direction;
the nadir-facing sub-antenna is disposed on the top surface; and
the EoC-facing sub-antenna is one of four EoC-facing sub-antennas, each disposed on a respective one of the four side surfaces.

20. The method of claim 16, wherein:
the plurality of sub-antennas is N sub-antennas;
the N sub-antennas are grouped into M disjoint subsets, N>2 and M<N, and all of the sub-antennas in any subset are substantially non-overlapping;
the nadir-facing sub-antenna and the EoC-facing sub-antenna are in different ones of the M subsets; and
the communicating comprises assigning a different carrier to each of the M subsets, such that the communicating is with the first portion of the ground terminals via a first carrier and concurrently with the second portion of the ground terminals via a second carrier.
